(19) United States
(12) Patent Application Publication
(10) Pub. No.: US 2025/0106686 A1
(43) Pub. Date: Mar. 27, 2025

(54) METHOD, DEVICE AND SYSTEM FOR MODIFYING A COMMUNICATION INFRASTRUCTURE

(71) Applicant: Orange, Issy-les-Moulineaux (FR)

(72) Inventors: Bruno CHATRAS, Chatillon (FR); Antoine MOUQUET, Chatillon (FR)

(21) Appl. No.: 18/728,253

(22) PCT Filed: Jan. 4, 2023
(86) PCT No.: PCT/EP2023/050119

§ 371 Date: Jul. 11, 2024

(30) Foreign Application Priority Data
Jan. 12, 2022 (FR) FR2200222

(51) Int. Cl. H04W 28/084; H04L 41/342; H04W 36/08; H04W 76/11

(52) U.S. Cl. CPC H04W 28/084; H04L 41/342; H04W 36/08; H04W 76/11

(57) ABSTRACT

A method, a device and a system for modifying a communication infrastructure able to provide a communication service to a terminal via a plurality of virtualized functions, are described. The method is implemented in a management device of the infrastructure, and includes receiving information in relation to attachment or detachment of the terminal to or from an access station of the communication infrastructure, and determining an adaptation of the plurality of virtualized functions on the basis of the location of the access station to which the terminal is attached or the location of the terminal). An adaptation method and device for instantiating the updating of the communication structure on the basis of the adaptation determined by the management device are also described.

### 1. TECHNICAL FIELD

The invention is intended to be implemented in a communication network routing data from or to terminals capable of being attached to separate access points of the communication network. More specifically, the invention describes a method, a device and a system for modifying a network made up of virtualized functions on the basis of the location of the user terminal or the access point to which the terminal is attached.

### 2. PRIOR ART

Communication networks, and in particular mobile communication networks, incorporate procedures enabling their users to remain contactable while on the move and ensure the continuity of the communications that they receive and send while on the move and attached to different access points of a communication network.

It is also accepted that mobile networks of the fifth and subsequent generations will be deployed using virtualization techniques, meaning that the various communication network functions required to register terminals, authenticate them and route their data will be implemented in virtualized form. Therefore, the network functions of a 5G core network and certain application functions (AF) under the responsibility of the operator and accessible from the core network are typically deployed in the form of virtualized network functions (VNF). A virtualized network function comprises software providing the required service and running in a virtual machine or container created on a commodity physical server, i.e., a server that is not specific to the function provided. Therefore, a communication infrastructure comprises one or more virtualized functions deployed on a virtualization infrastructure comprising physical servers hosting said virtualized functions and equipments interconnecting the physical servers. The virtualization infrastructure is typically made up of pools of commodity servers distributed geographically over several sites, for example in data centers, also referred to as computing centers, at varying distances from user terminals.

NFV technology, which was developed by ETSI and used to deploy a communication infrastructure based on a virtualization infrastructure, makes it possible to create and even move a virtualized function instance within the virtualization infrastructure, and therefore the corresponding network function or application function instance or instances. The virtualized function may therefore, for example, be moved from one server to another, from one data center to another, depending on various optimization criteria such as the load on a data center's servers or the communication latency induced by the position of a virtualized function or an application function relative to the users served. Indeed, the position of a network function or an application function relative to the user terminal that it serves has a fairly clear influence on the latency of the data session of the user terminal, particularly in the case of a network or application function processing user-plane flows, i.e., the payload data between the user terminal and another user terminal or a data server. The location of a server supporting a UPF (User Plane Function) entity of a 5G core network, a video transcoding gateway, or a CDN (Content Delivery Network) cache server, for example, has a significant impact on the data latency of user terminals using one or another of these functions.

The prior art, and in particular the 3GPP specifications for 5G networks, defines how to instantiate the distribution of UPFs over a territory in a predefined manner and select or reselect the one best placed to route a given traffic flow from or to a user. It involves selecting, based on the location of a user terminal, an instance of a network or application function that has already been deployed. The approach that involves deploying several instances of the same network or application function, with these instances being distributed geographically, is not optimal when these functions are dedicated to one user or group of users and/or when the territory over which these instances are deployed is very large but the population density is low. This solution is also rather static and does not offer a simple, inexpensive way of meeting the needs of user terminals on the move, which nevertheless require good quality of service and, in particular, latency that is sufficiently low to maintain a good user experience, in particular, or to meet the needs of an application, for example. If a high quality of service is required for users, it is necessary to deploy a large number of virtualized functions so that such functions are always available, regardless of the location of the user. This represents a significant cost and an infrastructure that is technically more complex to manage.

The object of the present invention is to provide improvements with respect to the prior art.

### 3. DISCLOSURE OF THE INVENTION

The invention improves the situation by means of a method for modifying a communication infrastructure able to provide a communication service to a terminal via a plurality of virtualized functions, said method being implemented in a management device of the infrastructure, and comprising
receiving information in relation to the attachment or detachment of said terminal to or from an access station of the communication infrastructure,
determining an adaptation of the plurality of virtualized functions on the basis of the location of the access station to which the terminal is attached or the location of the terminal.

The modification method is novel and inventive because it makes it possible to adapt a communication infrastructure comprising virtualized functions, whether network functions or application functions, on the basis of the location of a terminal.

The communication infrastructure is built on a virtualization infrastructure, in particular comprising physical servers, and modifying the communication infrastructure by adapting virtualized functions comprises updating the virtualization infrastructure, for example creating or removing virtual machines or containers.

The location of a terminal, in particular when it moves or attaches itself to a new access station while remaining static, may require the modification of one or more virtualized functions, for example to correct an excessive distance between the location of the terminal and the virtualized function, or to adapt the capacities of a virtualized function that needs to support more traffic due to a larger number of terminals in the geographical area that the function serves or indeed to adapt to the capacities or functions of the new access station to which the terminal is attached. Thus, by receiving information on the location of the terminal, for example, in relation to a location of the access station, the management device determines the updating of the plurality of virtualized functions, for example by adding and/or updating one or more virtualized network functions. The management device can receive information relating to the attachment directly from the terminal, or from the access station to which the terminal is attached, or indeed from another device of the network such as an MME (Mobility Management Entity), AMF (Access and Mobility Management Function) or NWDAF (Network Data Analytics Function) equipment.

According to one aspect of the invention, in the modification method, the information relating to the attachment follows a change of access station of the communication infrastructure to which the terminal is attached.

The method is in particular advantageous when the terminal is on the move and attaches itself successively to access stations that are distant from one another, for example, but not exclusively, while having an active session. It is then necessary for network and/or application functions to be adapted to the change in location of the terminal so that the active session maintains the same level of quality and availability.

According to another aspect of the invention, in the modification method, the adaptation comprises at least one of the following operations:
deploying a virtualized function in the communication infrastructure,
moving a virtualized function in the communication infrastructure,
removing a virtualized function from the communication infrastructure,
modifying a virtualized function in the communication infrastructure.

The adaptation, or updating, may be characterized by one or more operations depending on the type of terminal, the new access station, the characteristics of the data session that may be underway when the access station is changed, and the virtualized function to be updated. Therefore, a new virtualized function may be requested and added to the plurality for functional adaptation to the session or terminal or to ensure routing that complies with the quality of service requirement. A virtualized function may also be moved from one data center to another, which may particularly be justified when a data center is located close to an access station, for example in MEC (Mobile Edge Computing) architectures. A virtualized function of the plurality may also be removed if it is no longer required following attachment or detachment or indeed a virtualized function may be modified in order to adapt to the volume of data received from the terminal or routed to the terminal or indeed to support a new protocol or protocol version, for example. The adaptation may relate to a plurality of virtualized functions, for example, in the event that a session is established according to a chain of virtualized functions and the update may be different, in accordance with the options indicated above, depending on the virtualized function in question.

Since the communication infrastructure is based on a virtualization infrastructure, deploying, moving, removing or modifying a virtualized function in the communication infrastructure comprises updating the virtualization infrastructure and positioning the virtualized functions in the physical servers of the virtualization infrastructure. In particular, moving a virtualized function in the communication infrastructure may correspond to moving a virtualized function from one server to another of the virtualization infrastructure.

According to another aspect of the invention, in the modification method, the adaptation of the plurality comprises adding and/or moving and/or removing and/or modifying a component of at least one virtualized function of the plurality.

A virtualized function may advantageously comprise distinct components such as network or application protocols, functions relating to quality of service, administration functions, and the update may advantageously relate to the update of one or more of these components. Modifying a component includes, but is not limited to, creating, deleting, updating and moving a component instance in one or more virtualized functions of the plurality adapted by updating one or more components. The adaptation implemented from a component comprises, in particular, actions (adding, moving, removing, modifying) relating to a component in a virtualized function or an action relating to a component in a server of the virtualization infrastructure. Therefore, moving a component comprises moving a component from one virtualized function to another virtualized function, possibly in the same server, or from one server to another server of the virtualization infrastructure.

According to another aspect of the invention, the modification method comprises transmitting, beforehand, to a mobility management device of said terminal, a request to subscribe to information relating to the attachment of the terminal to an access station.

In order to limit the terminal location information transmissions received by the management device and thus to avoid overloading the communication network with signaling messages, the method may first involve the management device subscribing to information relating to the attachment of the terminal. The subscription may be made to the equipment (access station, AMF, MME, NWDAF) responsible for transmitting messages relating to the attachment of a terminal or indeed to a network administration equipment responsible for configuring these equipments.

According to another aspect of the invention, the modification method further comprises comparing an identifier of said terminal with a list of identifiers of terminals suitable for benefiting from the modification method.

The method may be implemented for a limited number of terminals, for example depending on their type, subscription, the application services they support, and the management device can then implement the method only if the terminal concerned by the attachment message is in the list of terminals in question. The list of terminals may be maintained by the management device or indeed by another device, for example a UDM (Unified Data Management) device, which can interact with the management device. This list may advantageously be negotiated with the transmitter of the messages relating to the attachment of the terminal.

According to another aspect of the invention, the modification method further comprises configuring a function capable of interacting with a virtualized function of the adapted plurality following the attachment or detachment of the terminal.

The adaptation of a virtualized function, or an elementary component thereof, of the plurality, may be accompanied by the configuration of a function, which may or may not be virtualized, linked or communicating with the updated virtualized function. Therefore, in the case of a chain of virtualized functions or a graph of virtualized functions, modifying one of the virtualized functions of the chain may require one or more other functions that are not part of the plurality to be modified. For example, if the update consists of adding a new protocol, it is possible that this new protocol is also required in other functions or equipments of the communication infrastructure.

According to another aspect of the invention, the modification method further comprises receiving an item of data relating to a session of said terminal and determining the adaptation as a function of the received data.

The reception of information on the attachment of a terminal may be supplemented by information on a session of the terminal. The information on the session, for example on its throughput, its quality of service in terms of latency, for example, or indeed the type or number of recipients of the session data, may be taken into account in order to adapt the most suitable update, typically a modification of an existing virtualized function or the addition of a new virtualized function.

According to another aspect of the invention, the modification method further comprises transmitting at least one configuration message to an orchestration device and/or to the virtualized function of the plurality impacted by the determined action.

Once the adaptation has been determined, i.e., one or more virtualized functions or components thereof need to be modified, moved, added or removed, this adaptation may advantageously be implemented by transmitting a configuration message to an orchestration device responsible for managing services deployed from the virtualized functions of the plurality and/or a configuration message to a virtualized function impacted by the adaptation. Depending on the determined adaptation, only the orchestration device must receive a configuration message, or only one or more impacted virtualized functions receive a configuration message, or indeed the adaptation requires a configuration message to be transmitted to the orchestration device and a configuration message to be transmitted to one or more virtualized functions. In the latter case, the configuration messages may advantageously be specific to the configuration device and to each of the virtualized functions concerned by the determined adaptation.

The different aspects of the modification method that have just been described can be implemented independently of each other or in combination with each other.

The invention also relates to a device for modifying a communication infrastructure able to provide a communication service to a terminal via a plurality of virtualized functions, implemented in a management device of the infrastructure and comprising:
a receiver capable of receiving information relating to the attachment or detachment of said terminal to or from an access station of the communication infrastructure,
a determination module capable of determining an adaptation of the plurality of virtualized functions on the basis of the location of the access station to which the terminal is attached or the location of the terminal.

This modification device is capable, in all of its embodiments, of implementing the modification method that has just been described.

The invention also relates to a method for adapting a communication infrastructure able to provide a communication service to a terminal via a plurality of virtualized functions, said method being implemented in a virtualized function or an orchestration device of the plurality of virtualized functions, and comprising:
receiving, from the management device, a configuration message for configuring at least one virtualized function of the plurality on the basis of the location of an access station to which the terminal is attached or the location of the terminal,
updating said at least one virtualized function relating to the received configuration message.

The invention also relates to a device for adapting a communication infrastructure able to provide a communication service to a terminal via a plurality of virtualized functions, said device being implemented in a virtualized function or an orchestration device of the plurality of virtualized functions, and comprising:
a receiver capable of receiving, from the management device, a configuration message for configuring at least one virtualized function of the plurality on the basis of the location of an access station to which the terminal is attached or the location of the terminal,
an update module capable of updating said at least one virtualized function relating to the received configuration message.

This adaptation device is capable, in all of its embodiments, of implementing the adaptation method described above.

The invention also relates to a system for modifying a communication infrastructure able to provide a communication service to a terminal via a plurality of virtualized functions, characterized in that it comprises:
a modification device,
at least one adaptation device.

The invention also relates to computer programs comprising instructions for implementing the steps of the respective modification and adaptation methods that have just been described, when these programs are both executed by a processor and a storage medium that can be read respectively by a modification and adaptation device on which the computer programs are stored.

The programs mentioned above may use any programming language and be in the form of source code, object code or code intermediate between source code and object code, such as in a partially compiled form, or in any other desirable form.

The data media mentioned above may be any entity or device capable of storing the program. For example, a medium may comprise a storage means such as a ROM, for example a CD ROM or a microelectronic circuit ROM, or a magnetic recording medium.

Such a storage means may, for example, be a hard disk, a flash memory, etc.

A data medium may be a transmissible medium such as an electrical or optical signal, which can be conveyed via an electrical or optical cable, by radio or by other means. A program according to the invention may in particular be downloaded from an Internet-type network.

Alternatively, a data medium may be an integrated circuit into which a program is incorporated, the circuit being designed to execute or be used in the execution of the methods in question.

### 4. BRIEF DESCRIPTION OF THE DRAWINGS

Other features and advantages of the invention will become clearer on reading the description that follows of particular embodiments, provided as illustrative and non-limiting examples, and viewing the appended drawings in which:

FIG. 1 describes a communication infrastructure in which the modification method according to one embodiment of the invention is implemented,

FIG. 2 describes a communication infrastructure in which the modification method according to another embodiment of the invention is implemented,

FIG. 3 describes the implementation of the modification method according to another embodiment of the invention,

FIG. 4 describes a device for modifying a communication infrastructure according to one aspect of the invention,

FIG. 5 describes an adaptation device of a communication infrastructure according to one aspect of the invention.

### 5. DESCRIPTION OF THE EMBODIMENTS

Hereinafter in the description, embodiments of the invention in a communication infrastructure are disclosed. This infrastructure may be implemented to route communication data to fixed or mobile terminals. The infrastructure is implemented at least partially using virtualized functions, these functions being able to correspond to network functions (addressing, routing, security, quality of service management, etc.) or to application functions (enhancement, optimization, load balancing, application security, etc.). This infrastructure may also comprise equipments implementing the functions in a non-virtualized mode. This infrastructure may be used to route and/or process payload and control data of residential or business customers and may comprise functions relating to access and/or to a core network.

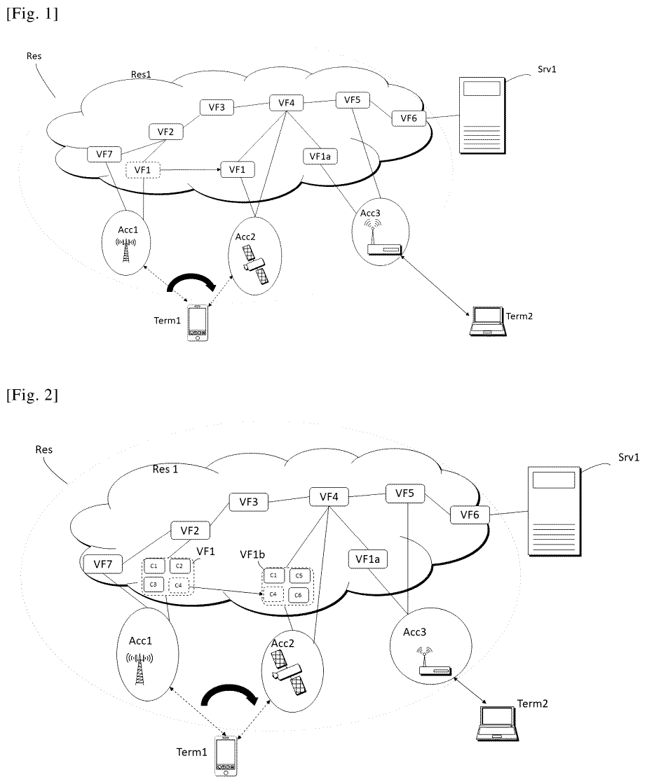

Reference is first made to FIG. 1, which shows a communication infrastructure in which the modification method according to one embodiment of the invention is implemented.

The communication infrastructure Res, which may also be referred to as a communication network, comprises 3 access stations respectively referred to as Acc1, Acc2 and Acc3. The 3 access stations Acc1, Acc2, Acc3 implement different technologies: cellular technology (3G, 4G, 5G, etc.) for Acc1, satellite technology for Acc2 and Wi-Fi technology for Acc3, respectively. These technologies are examples only, and are neither exhaustive nor required. The 3 access technologies could, for example, be of the same type, for example cellular, and the infrastructure Res could also comprise a higher number of access stations or indeed only one or two access stations. According to another example, one or more of the access stations Acc1, Acc2, Acc3 are of the “fixed” type and can correspond to wired access points for fiber or xDSL (digital subscriber line) type accesses, for example. The access stations in this case may then be, for example, a CPE (Customer Premises Equipment) such as a box or an access equipment in an operator's network (DSLAM (Digital Subscriber Line Access Multiplexer) or optical connection node).

The communication infrastructure Res further comprises a routing network Res1 which could, for example, be a core network to which the different access stations are connected, this network Res1 being operated, for example, by a telecommunications operator. This network Res1 comprises a plurality of virtualized functions VF1, VF2, . . . , VFn responsible for applying a processing operation to data passing through the network Res1. For example, if a data session is established between the terminal Term1 and the data server Srv1, the information required to manage, control or establish this session and the data transmitted in this session may be processed by some or all of the virtualized functions VF1, VF2, VF3, VF4, VF5 and VF6, VF7 before being received by the server Srv1. These virtualized functions may provide a processing operation relating to the management of the terminals (registration, mobility) or data routing, in which case these functions are referred to as network-level virtualized functions, or they may provide a processing operation for the transferred payload data, i.e., application data, in which case they are referred to as virtualized application functions. According to one example, one or more of the virtualized functions VF1, . . . , VF7 may also be implemented using non-virtualized “hardware” equipment interacting with the other virtualized functions.

The virtualized functions VF1, VF2, . . . , VFn are implemented in data centers, also referred to as computing centers. These data centers may be distributed to a greater or lesser extent, and in some networks, distributed data centers are deployed as close as possible to the access stations, in particular so that the data services of the terminals benefit from good quality of service, in particular in terms of latency. This is particularly the case with MEC (Mobile Edge Computing) architectures. The different terminals Term1 and Term2, and in particular the applications on the terminals at the origin of the data exchange with the data server Srv1, do not necessarily require the same virtualized functions, or the same requirements in terms of data routing or processing. Similarly, the type of access station may influence the type of virtualized function to be invoked for data transport. For example, a virtualized function may be required to manage the quality of service for the terminal Term1 attached to a satellite access (Acc2) whereas this same virtualized function will not be required for a cellular access (Acc1). In this case, the type of access station (satellite or cellular) therefore affects the update of the communication network by requiring a new virtualized function or a new component in a virtualized function to manage, for example, the degraded quality of service (latency) caused by satellite access.

Attaching a terminal to an access station requires the communication infrastructure Res and, more particularly, one or more of the virtualized functions of the infrastructure Res, to be updated. For example, attaching the terminal Term1 to the access station Acc1 requires, according to one example, a virtualized function to be instantiated as close as possible to the access station Acc1. Indeed, in the event that virtualized functions are instantiated in a data center that is centralized and therefore quite far from the access station Acc1, it may be necessary to deploy a new virtualized function close to the access station Acc1, for example to improve connection times for the terminal Term1 or to improve the quality of the data service of the terminal Term1. The virtualized function VF1 to be instantiated may be a virtualized network function if, for example, the aim is to optimize the routing of data from the terminal Term1 in the network Res1 or indeed a virtualized application function if the aim is, for example, to improve the latency of the data service and/or the quality of experience for the client of the terminal Term1. According to one example, the virtualized function VF1 may already be instantiated and it is not necessary to intervene on this virtualized function when the terminal Term1 is attached. If the terminal Term1 moves or if the access station Acc1 becomes unavailable or if the terminal Term1 selects another access station Acc2, it may be necessary to move the function VF1 initially deployed as close as possible to the access station Acc1 to a more suitable data center, for example as close as possible to the station receiving the satellite signal from the access station Acc2 or to a data center adapted to the data flows transmitted by satellite link. In the example of FIG. 1, updating the communication infrastructure Res, and therefore the network Res1 made up of the virtualized functions VF1, . . . , VF7, consists, depending on the scenario, in deploying or creating a virtualized function or moving a virtualized function. In another scenario not described in FIG. 1, the update may consist in removing a virtualized function. For example, in the event that a virtualized function VF1a is no longer used by the terminals attached to the access station Acc3, it may be envisaged that this function V1Fa could be removed from the data center in which it is deployed in order, for example, to preserve computing resources for other virtualized functions of the data center, or to reduce the number of licenses required to maintain the different instances of the same virtualized function in the infrastructure Res. According to yet another example, modifying a virtualized function may be envisaged in order to adapt the network made up of the different virtualized functions VF1, . . . , VF7. For example, this may involve instantiating a new appropriate protocol in the virtualized function VF1a when the terminal Term2 attaches itself to the access station Acc3. For example, as the terminal Term2 is a mobile PC, it may be necessary to deploy a new security module or a VPN (Virtual Private Network) server in one of the virtualized functions VF1, . . . , VF7 of the infrastructure Res. According to another example, the modification of the virtualized function VF1a may consist in adding new data routing and/or processing resources due to the greater number of terminals attached to the access station Acc3. Such an adaptation of all of the virtualized functions VF1, . . . , VF7, consisting in this case in modifying one of the virtualized functions of the communication infrastructure Res, thus makes it possible to adapt the resources of the communication infrastructure Res functionally and quantitatively to the needs of the terminals attached to this infrastructure. It should also be noted that modifying the network of virtualized functions VF1, . . . , VF7 of the communication infrastructure Res by adding and/or removing and/or moving and/or modifying a virtualized function may also require the modification of another virtualized function or another physical equipment interacting with the virtualized function which is the subject of the modification, such as one or more virtualized functions from among VF1, VF2, VF3, . . . , VF7 or an equipment of the infrastructure Res or external to the infrastructure Res not shown in FIG. 1. For example, if a new virtualized function is added, it may be necessary to modify the security configurations of one or more of the virtualized functions cited above, and indeed also the configuration of the server Srv1.

According to one example, the modification of the communication infrastructure Res, after the attachment of a terminal Term1, is implemented only if the terminal Term1 belongs to a list of terminals for which the modification is authorized, this list being managed by a management device of the network Res or in a database external to this management device but accessible to the management device. For example, an operator of the infrastructure may consider that, if the client of the terminal Term1 is one of the clients that has a subscription enabling, for example, a stable quality of service to be maintained, the adaptation of the virtualized functions can be implemented. According to another option, the modification may be implemented only if the terminal Term1 is identified as a terminal of a certain type (PC, smartphone, etc.), or if the terminal Term1 has a particular protocol (for example, a security protocol) and requires a particular virtualized function or a particular component in one or more virtualized functions, for example.

According to another example, the modification of the communication infrastructure Res is implemented as a function of data from a payload or signaling data session established by the terminal Term1. Therefore, for example, if the data identifies a session requiring low latency and/or if the session is secure and/or if the session is established using a particular protocol, the modification of the infrastructure Res will be determined as a function of the data received.

A combination of these different implementation examples, for example based on an identification of the terminal and a data session, may also be used according to another example.

Reference is next made to FIG. 2, which shows a communication infrastructure in which the modification method according to another embodiment of the invention is implemented.

In this embodiment, elements of the infrastructure as shown in FIG. 1 are represented. This embodiment differs from the embodiment of FIG. 1 in terms of the structure or the composition of the virtualized functions VF1 and VF1b. The other virtualized functions VF1a, VF2, . . . , VF7 may themselves be structured like the two functions VF1 and VF1b.

The virtualized function VF1 comprises 4 components referred to as C1, C2, C3, C4. These four components can respectively provide software components proposing network functions or application functions. The virtualized function VF1b comprises 3 components referred to as C1, C5, C6. There is no limit to the number of components included in the virtualized functions VF1 and VF1b and one component may itself comprise a plurality of components. For example, it may be considered that a virtualized function VF1 comprises 3 components, a network, application and security component respectively, and that each of these components itself comprises components.

The terminal Term1 initially attached to the access station Acc1 uses components of the function VF1 and components of the other virtualized functions VF2, VF3, . . . , VF7 during a data session, whether it is an application session with the server Srv1 or a signaling procedure with the network Res1.

When the terminal Term1 changes attachment point and is then attached to the access station Acc2, a management device not shown in FIG. 2 modifies the communication infrastructure Res when it is informed by the terminal Term1 or the access station Acc1 or indeed by the access station Acc2 of the change of access station for the terminal Term1. This modification comprises, in particular, the movement of the component C4 from the virtualized function VF1 to the virtualized function VF1b. According to another example, it may be a case of moving the component C4 from one physical server hosting a virtualized function to another physical server of the communication infrastructure and, more particularly, of the virtualization infrastructure on which the communication infrastructure is implemented. It should be noted that this modification may occur with the data session established and maintained during the change from access station Acc1 to Acc2 for the terminal Term1, in accordance with handover techniques, or in the absence of an established session, when the terminal Term1 changes access station while it is not transmitting and/or receiving data. This modification may also take place when the terminal Term1 initiates a new data session with the server Srv1, the modification being able to take into account a characteristic of the session, for example. The moved component C4, corresponding to the adaptation of the virtualized functions in this embodiment, can be either a network or application component, or indeed a set of components, enabling the terminal Term1 to have or continue to have the functionality provided by the component C4 and/or to obtain a quality of experience as expected during the change from access station Acc1 to Acc2.

In this embodiment, reference is made to moving a component from a virtualized function VF1 to a virtualized function VF1b, but the implementation of components also makes it possible, depending on the scenario, to deploy a new component in the virtualized function VF1b, to remove a component from the function VF1 if it is no longer required, or to modify a component of the virtualized function VF1 and/or VF1b.

In a manner identical to the embodiment of FIG. 1, modifying the communication infrastructure Res by adapting virtualized functions, comprising adding and/or removing and/or moving and/or modifying a component of one or more virtualized functions, may also require another virtualized function or a physical equipment to be modified, such as one or more virtualized functions from among VF2, VF3, . . . , VF6, VF7 of the network Res1 or external to the network Res1 or even to the infrastructure Res. For example, if a new component corresponding to a routing protocol is added to the virtualized function VF1b, it may be necessary to modify the different virtualized functions or physical equipments of the communication infrastructure Res, for example the functions VF4, VF5 and VF6, and the server Srv1, with this same component, so that the data flows from the terminal Term1 can be routed to the server Srv1 using this new protocol and the infrastructure Res modified with the new component.

The implementation examples of the modification of the communication infrastructure Res, based in particular on the identification of the terminal Term1 and on the data of an end-to-end session established by the terminal Term1, as described above for FIG. 1, are also possible in this embodiment.

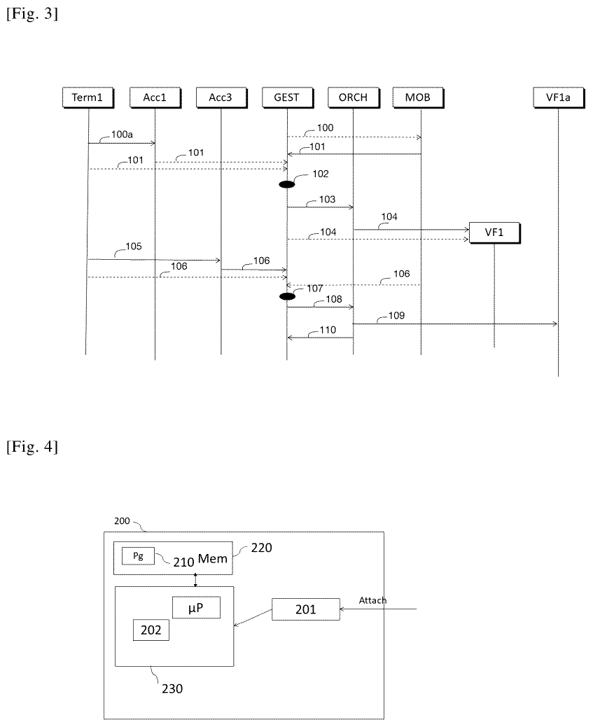

Reference is next made to FIG. 3, which describes the implementation of the modification method according to another embodiment of the invention.

The entities Term1, Acc1 and Acc2 shown in FIG. 1 and FIG. 2 are included in this FIG. 3. Furthermore, the communication infrastructure Res comprises a management device GEST comprising a modification device implementing the modification method described below. This management device GEST may be implemented in a virtualized or non-virtualized form in the communication infrastructure Res and may be collocated in the same equipment as the orchestration device ORCH and/or mobility device MOB described below. The mobility device MOB is capable of managing the attachment of Term1 to the access entities Acc1 and Acc2 of the communication infrastructure Res and may be implemented, for example, in an MME (Mobility Management Entity), AMF (Access and Mobility Management Function), GMLC (Gateway Mobile Location Center) or NWDAF (Network Data Analytics Function) equipment or an access station Acc1, Acc2. The MME, AMF, GMLC or NWDAF equipments may further be implemented in one or more virtualized functions, such as the functions VF1 . . . VF7 of FIG. 1 or FIG. 2. The device MOB is capable of possibly communicating with the access entities Acc1 and Acc2, and possibly with the terminal Term1 and with the device ORCH. The orchestration device ORCH is a device capable of managing the instances of virtualized functions VF1, VF1a, . . . , VF7 of the communication infrastructure Res, or the instances of the components C1, C2, . . . , Cn when such components are deployed. Such a device ORCH may, for example, be implemented in an orchestrator entity managing the virtual instances of the communication infrastructure Res, in conjunction, for example, with virtualized function managers, if it is a communication infrastructure, for example deployed according to NFV (Network Function Virtualization) principles.

During an optional first step 100, the management device GEST transmits a message to the mobility device MOB requesting subscription to information relating to the attachment of the terminal Term1 to an access station Acc1 and Acc2. By means of this message, when the management device GEST is informed of a new attachment of the terminal Term1 to one of the access stations Acc1, Acc2, or of a change of attachment of the terminal Term1 from the access station Acc1 to Acc2 or vice versa, or of a detachment of the terminal Term1 from one of the access stations Acc1 and Acc2, or a modification of the attachment of the terminal Term1 to one of the access stations Acc1 and/or Acc2, the mobility device MOB informs the management device GEST. This step is optional because, according to another example, the terminal Term1 may itself inform the management device GEST of one of the changes indicated above or indeed, according to another example, the access devices Acc1 and Acc2 may inform the management device GEST. Implementing a mobility device MOB is advantageous in order for the management device GEST to be able to receive information linked to attachments possibly concerning several terminals and access entities in a single message, reducing the number of messages received and to be processed by the management device GEST, and also in order for the mobility device MOB to carry out pre-processing and not transmit all of the attachment modifications if these do not require the communication infrastructure Res to be modified.

According to one alternative, the subscription request message transmitted during the step 100 comprises one or more identifiers of terminals for which the management device GEST wishes to be notified of a modification to an attachment to an access station Acc1 and Acc2.

During a step 101, the management device GEST receives information relating to the attachment of the terminal Term1 to the 5G type access station Acc1 of the communication infrastructure Res, this attachment having taken place during the step 100a. The access station is, for example, a gNB entity. This information may be transmitted to the device GEST by the mobility device MOB if the management device GEST has subscribed to the attachment information in accordance with the step 100 or this attachment information may be transmitted by the access station Acc1 hosting the terminal Term1 or indeed by the terminal Term1. According to another example, the information relates to the detachment of the terminal Term1 from the access station Acc1 or to a modification of the attachment of the terminal Term 1 to the access station Acc1, this modification being able to be linked to a change of quality of service, a change of security parameter or the establishment of a new data session by the terminal Term1. According to this latter example, the establishment of a new data session may require more resources in the communication infrastructure Res for the terminal Term1 or a change in the characteristics of the resources already allocated to this terminal Term1.

Upon receiving the information on the attachment of the terminal Term1 to the access station Acc1, the management device GEST determines, during a step 102, an action to adapt the virtualized functions of the communication infrastructure Res. This determination may take into account the geographical and/or topographical location, i.e., the location in the communication infrastructure Res of the access station Acc1, and/or the geographical and/or topological location of the terminal Term1. The information on the location of the terminal Term1 may be obtained in the information message received during the step 101, or directly from the terminal Term1 in a step not shown in FIG. 3. The determination action may consist in deploying a new virtualized function, for example, as described in specification ETSI GS NFV-SOL016 (https://www.etsi.org/deliver/etsi_gs/NFV-SOL/001_099/016/02.08.01_60/gs_NFV-SOL016v020801p.pdf), moving an existing virtualized function, removing an existing virtualized function if it is no longer required after the attachment or detachment of the Term1, or indeed modifying a virtualized function, for example by adding processing resources or a new application function. The adaptation may also comprise adding, modifying, removing or moving several virtualized functions.

The virtualized functions or, more precisely, the virtualized resources that support them, are then created or moved using resource migration mechanisms specific to the virtualized resource management technology used, for example OpenStack or Kubernetes.

All of these determination actions may also only relate to one component of one or more virtualized functions if this virtualized function is made up of one or more components linked to routing or application processing. This determination action may also depend on a data session established between the terminal and a remote application server such as the server Srv1 shown in FIG. 1 and FIG. 2.

According to one alternative, the determination action may further comprise comparing an identifier of the terminal Term1 with a list of identifiers of terminals managed by the management device or by an external entity that is not shown, with which the management device communicates. This list of terminals makes it possible to determine whether a determination action needs to be implemented and/or, if a determination action is implemented, the type of action to be determined. For example, the modification method may be valid only for a list of terminals determined by their identifiers, or the addition of a component to a virtualized function may be valid only for certain terminals. This list of identifiers can therefore be used to determine different actions depending on a type of terminal or a type of subscription for a terminal. The identifier of the terminal Term1 may be obtained during the information step 101 or indeed directly from the terminal Term1.

According to another alternative, the determination action comprises modifying another virtualized function or another non-virtualized equipment of the communication infrastructure Res or an equipment external to the infrastructure Res. In this latter case, the adaptation may comprise an exchange with a management entity responsible for this equipment external to the infrastructure Res. According to one example, the movement of a virtualized function may require a routing table for other functions or other equipments of the infrastructure Res to be updated. According to another example, a modification of a virtualized function is determined and this update is registered in a database of the device GEST or the orchestration device ORCH following the step described below, or in an external database, for example of the NRF (Network Repository Function) or DNS (Domain Name System) type in a step not shown in FIG. 3, bearing in mind that it is also possible to deploy an external database in addition to a database in the device GEST or ORCH. The registration of an update of a virtualized function in a database is valid whether the update corresponds to a modification, a creation, a movement or a deletion of a virtualized function and/or a component of a virtualized function. The other virtualized functions and/or equipments of the infrastructure Res may therefore access this database, regardless of the form it takes above, in order to interact with the moved or newly deployed virtualized function.

During an optional step 103, the management device GEST transmits a configuration message to the orchestration device ORCH allowing the adaptation determined during the step 102 to be implemented. According to one example, this configuration message may comprise the type of virtualized function to be instantiated, if it is a creation, and the configuration information (location, parameters, etc.) of this virtualized function, or the modification to be made to a virtualized function identified in the update message, and possibly the required update period. In this example, the update action comprises creating a virtualized function VNF1 in the communication infrastructure Res. According to one example, if the device ORCH is an NFVO entity, the management device GEST transmits an UpdateNs request, as described in ETSI GS NFV-IFA 013, to the device ORCH (NFVO), to add a virtualized function instance (VNF) to the network service NS (Network Service) corresponding in this example to the network Res. The configuration action comprises both the action of modifying an existing virtualized function and instantiating a new virtualized function. Indeed, a configuration message transmitted to the device ORCH to instantiate a new virtualized function enables the communication network to be adapted to the event occurring when the communication network is accessed. According to another alternative, during the step 103, the device GEST transmits the configuration message directly to the virtualized function impacted by the adaptation, or to the impacted virtualized functions if there are several of them. According to this example, the device GEST configures the virtualized function or functions impacted by the adaptation. According to yet another alternative, a configuration message is sent to the device ORCH and to one or more virtualized functions. In this case, the configuration message transmitted to the device ORCH and the message transmitted to one or more virtualized functions may be different. For example, the adaptation may consist in transmitting a message to the device ORCH in order for a virtualized function to have more processing resources and a different configuration message may be sent to one or more of the virtualized functions for application updating, which may be carried out without the intervention of the device ORCH. The configuration messages sent to different virtualized functions may themselves be specific to the virtualized functions, for example in the event that different protocols are instantiated in the virtualized functions impacted by the adaptation.

During the step 104, the orchestration device ORCH and/or the device GEST, via the message sent to the virtualized function or functions, performs the update by creating the virtualized function VF1 and configuring this function VF1 in accordance with the information received in the step 103, the configuration being able to comprise the addition or removal of software resources, for example, and/or the configuration of a protocol or an application executed by the function VF1. This configuration may be carried out following a reservation of resources in a data center hosting the created virtualized function VF1. This configuration may be accompanied by an update of the database as described above. This update action may be implemented autonomously by the orchestration device ORCH and/or the device GEST or indeed in collaboration with another entity such as a VNFM (Virtual Network Function Manager) entity of the infrastructure Res.

During the step 105, the terminal Term1, which is initially attached to the access station Acc1, detaches itself from the access station Acc1 and attaches itself to the access station Acc3, for example in accordance with handover techniques or indeed when the terminal Term1 is in “idle” mode, i.e., when the terminal Term1 is not in communication during the change of access station. A data session established between the terminal Term1 and a data server that is not shown is maintained during this change of access station.

During the step 106, the access entity Acc3 transmits information to the management device GEST relating to a change of access and to the attachment of the terminal Term1 to the access station Acc3. According to one example, the information relating to the change of access of the terminal Term1 may be transmitted by the terminal Term1 or indeed by the mobility device MOB during the step 106.

According to one alternative, the access entity Acc3 also transmits information on the current data session of the terminal Term1.

During the step 107, the management device GEST determines that a virtualized function VF1a needs to be updated by adding a component capable of managing the current data session of the terminal Term1. This component is a module for optimizing the application service relating to the data session. The management device GEST takes into account the new location of the terminal Term1 and data from the current session, according to this this example.

During the step 108, the management device GEST informs the orchestration device ORCH of the update action to be implemented by transmitting the identity of the virtualized function VF1a, the component to be added, identified for example by a component name, to this virtualized function and possibly the data center where the component may be obtained. According to one alternative, the device GEST does not transmit the name of a component to the device ORCH but information relating to the deployment of the service which will then be used by a management device of the virtualized function VF1a, such as a VNFM (Virtual Network Function Manager), which identifies one or more components to be added on the basis of the information relating to the deployment of the service retransmitted by the device ORCH.

During the step 109, the orchestration device ORCH updates the virtualized function VF1a in accordance with the update information received during the step 108.

According to one alternative, during the step 110, the orchestration device ORCH transmits a message to the management device GEST indicating the effective update of the virtualized function VF1a so that the management device GEST has all of the up-to-date information on the virtualized functions in the communication infrastructure Res and can use this information when the infrastructure is next modified.

Reference is next made to FIG. 4, which shows a device 200 for modifying a communication infrastructure able to provide a communication service to a terminal via a plurality of virtualized functions, according to one embodiment of the invention.

Such a modification device may be implemented in a management device, such as an administration entity of a communication infrastructure or indeed in an administration entity of a communication infrastructure based on a virtualization infrastructure (VNF manager, orchestrator, etc.).

For example, the modification device 200 comprises a processing unit 230 equipped, for example, with a microprocessor μP, and controlled by a computer program 210 stored in a memory 220 and implementing the modification method according to the invention. Upon initialization, the code instructions of the computer program 210 are, for example, loaded into a RAM before being executed by the processor of the processing unit 230. Such a modification device 200 comprises:
a receiver 201 capable of receiving information Attach relating to the attachment or detachment of said terminal to or from an access station of the communication infrastructure,
a determination module 202 capable of determining an adaptation of the plurality of virtualized functions on the basis of the location of the access station to which the terminal is attached or the location of the terminal.

The term “module” may correspond to a software component or a hardware component or a set of hardware and software components, a software component itself corresponding to one or more computer programs or sub-programs or, more generally, to any element of a program able to implement a function or a set of functions.

FIG. 4 shows only a particular one of several possible ways in which the device 200 may be implemented in order for it to carry out the steps of the modification method as detailed above, in relation to FIG. 1, FIG. 2 and FIG. 3, in its various embodiments. Indeed, these steps may be carried out either on a reprogrammable computing machine (a personal computer, a digital signal processor or a microcontroller) running a program comprising a sequence of instructions, or on a dedicated computing machine (for example a set of logic gates such as an FPGA or an ASIC, or any other hardware module). If the device 200 is implemented with a reprogrammable computing machine, the corresponding program (i.e., the sequence of instructions) may or may not be stored in a removable storage medium (such as, for example, an SD card, a USB stick, a CD-ROM or a DVD-ROM), this storage medium being partially or totally readable by a computer or processor.

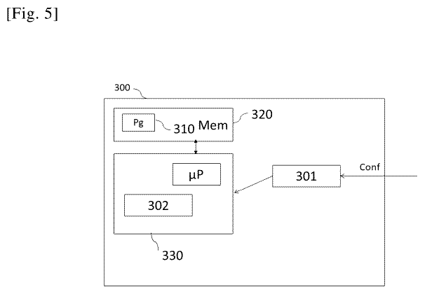

Reference is next made to FIG. 5, which shows a device 300 for adapting a communication infrastructure able to provide a communication service to a terminal via a plurality of virtualized functions, according to one embodiment of the invention.

Such an adaptation device may be implemented in virtualized form or in the form of specific equipment and may be instantiated in a virtualized function (VNF) or in an orchestration device of a virtualized architecture.

For example, the adaptation device 300 comprises a processing unit 330 equipped, for example, with a microprocessor μP, and controlled by a computer program 310 stored in a memory 320 and implementing the adaptation method according to the invention. Upon initialization, the code instructions of the computer program 310 are, for example, loaded into a RAM before being executed by the processor of the processing unit 330.

Such an adaptation device 300 comprises:
a receiver 301 capable of receiving, from a management device, a configuration message Conf for configuring at least one virtualized function of the plurality on the basis of the location of an access station to which the terminal is attached or the location of the terminal,
an update module 302 capable of updating said at least one virtualized function relating to the received configuration message.

The term “module” may correspond to a software component or a hardware component or a set of hardware and software components, a software component itself corresponding to one or more computer programs or sub-programs or, more generally, to any element of a program able to implement a function or a set of functions.

FIG. 5 shows only a particular one of several possible ways in which the device 300 may be implemented in order for it to carry out the steps of the adaptation method as detailed above, in relation to FIG. 1, FIG. 2 and FIG. 3, in its various embodiments. Indeed, these steps may be carried out either on a reprogrammable computing machine (a personal computer, a digital signal processor or a microcontroller) running a program comprising a sequence of instructions, or on a dedicated computing machine (for example, a set of logic gates such as an FPGA or an ASIC, or any other hardware module). If the device 300 is implemented with a reprogrammable computing machine, the corresponding program (i.e., the sequence of instructions) may or may not be stored in a removable storage medium (such as, for example, an SD card, a USB stick, a CD-ROM or a DVD-ROM), this storage medium being partially or totally readable by a computer or processor.

1. A method for modifying a communication infrastructure able to provide a communication service to a terminal via a plurality of virtualized functions, said method being implemented in a management device of the infrastructure, and comprising
receiving information (Attach) in relation to the attachment or detachment of said terminal to or from an access station of the communication infrastructure, and
determining an adaptation of the plurality of virtualized functions on the basis of a location of the access station to which the terminal is attached or a location of the terminal.

2. The method of claim 1, wherein the information relating to the attachment follows a change of access station of the communication infrastructure to which the terminal is attached.

3. The method of claim 1, wherein the adaptation comprises at least one of the following operations:
deploying a virtualized function in the communication infrastructure,
moving a virtualized function in the communication infrastructure,
removing a virtualized function from the communication infrastructure, or
modifying a virtualized function in the communication infrastructure.

4. The method of claim 1, wherein the adaptation of the plurality of virtualized functions comprises adding and/or moving and/or removing and/or modifying a component of at least one virtualized function of the plurality of virtualized functions.

5. The method of claim 1, further comprising transmitting, beforehand, to a mobility management device of said terminal, a request to subscribe to information relating to the attachment of the terminal to an access station.

6. The method of claim 1, further comprising comparing an identifier of said terminal with a list of identifiers of terminals suitable for benefiting from the modification method.

7. The method of claim 1, further comprising configuring a function capable of interacting with a virtualized function of the adapted plurality of virtualized functions following the attachment or detachment of the terminal.

8. The method of claim 1, further comprising receiving an item of data relating to a session of said terminal and determining the adaptation as a function of the received data.

9. The method of claim 1, further comprising transmitting at least one configuration message to an orchestration device and/or to the virtualized function of the plurality of virtualized functions impacted by the determined action.

10. A method for adapting a communication infrastructure (Res) able to provide a communication service to a terminal via a plurality of virtualized functions, said method being implemented in a virtualized function or an orchestration device of the plurality of virtualized functions, and comprising:
receiving, from a management device, a configuration message for configuring at least one virtualized function of the plurality of virtualized functions, the configuration message being associated with an adaptation, determined by the management device, of the plurality of virtualized functions, on the basis of a location of an access station to which the terminal is attached or a location of the terminal, and
updating said at least one virtualized function relating to the received configuration message.

11. A device for modifying a communication infrastructure able to provide a communication service to a terminal via a plurality of virtualized functions, implemented in a management device of the communication infrastructure and comprising:
a receiver capable of receiving information relating to the attachment or detachment of said terminal to or from an access station of the communication infrastructure,
the device capable of determining an adaptation of the plurality of virtualized functions on the basis of the location of a access station to which the terminal is attached or a location of the terminal.

12. A device for adapting a communication infrastructure able to provide a communication service to a terminal via a plurality of virtualized functions, said device being implemented in a virtualized function or an orchestration device of the plurality of virtualized functions, and comprising:
a receiver capable of receiving, from a management device, a configuration message for configuring at least one virtualized function of the plurality of virtualized functions, the configuration message being associated with an adaptation, determined by the management, of the plurality of virtualized functions, on the basis of a location of an access station to which the terminal is attached or a location of the terminal,
the device capable of updating said at least one virtualized function relating to the received configuration message.

13. A system for modifying a communication infrastructure able to provide a communication service to a terminal via a plurality of virtualized functions, the system comprising:
the modification device of claim 11, and
at least one adaptation device for adapting the communication infrastructure able to provide the communication service to the terminal via the plurality of virtualized functions, said adaptation device being implemented in a virtualized function or an orchestration device of the plurality of virtualized functions, and comprising a receiver capable of receiving, from the management device, a configuration message for configuring at least one virtualized function of the plurality of virtualized functions, the configuration message being associated with an adaptation, determined by the management, of the plurality of virtualized functions, on the basis of a location of an access station to which the terminal is attached or a location of the terminal, the adaptation device capable of updating said at least one virtualized function relating to the received configuration message.

14. A computer comprising a processor and a memory, the memory having stored thereon instructions which, when executed by a processor, cause the processor to implement the method of claim 1.

15. A non-transitory computer readable storage medium, having stored thereon instructions which, when executed by a processor, cause the processor to implement the method of claim 1.
